(19) United States
(12) Patent Application Publication
(10) Pub. No.: US 2010/0255827 A1
(43) Pub. Date: Oct. 7, 2010

(54) On the Go Karaoke

(75) Inventors: Connie Jordan, Laguna Niguel, CA (US); Christopher Carmichael, Laguna Niguel, CA (US); Sage Huls, Honolulu, HI (US)

Correspondence Address: Law Office of Scott C Harris Inc, PO Box 1389, Rancho Santa Fe, CA, 92067, US

(73) Assignee: UBIQUITY HOLDINGS, San Juan Capistrano, CA (US)

(21) Appl. No.: 12/754,339

(22) Filed: Apr. 5, 2010

Related U.S. Application Data
(60) Provisional application No. 61/166,665, filed on Apr. 3, 2009.

(51) Int. Cl. H04W 4/00; H04W 88/02

(52) U.S. Cl. 455/414.1; 455/550.1

(57) ABSTRACT

A karaoke program for a cellular phone allows downloading music and text, and then synchronizing operation between voice that is received and whether the voice is received at the right time for the text.

This application claims priority from 61/166,665, filed Apr. 3, 2009, the entire contents of which are herewith incorporated by reference.

### BACKGROUND

Phones and PDAs have continued to converge, and have reached a point where a phone has power similar to a small computer. Phones are often used to download music, and this has become a significant profit center for the carriers and downloaders. Users can download music to their phone, and later play back that music, e.g. in between using the phone for its communication function. The processing power of the phone is used to process and play back the music.

Summary The present application describes a karaoke plug-in for a portable phone with special functions that facilitate its use with downloaded media.

### BRIEF DESCRIPTION OF THE DRAWINGS

in the drawings:

FIG. 1 illustrates a portable phone with karaoke functions;

FIG. 2 shows style sheets for the lyrics in the music; and

FIG. 3 shows a flowchart of operation of scoring and otherwise operating according to an embodiment.

### DETAILED DESCRIPTION

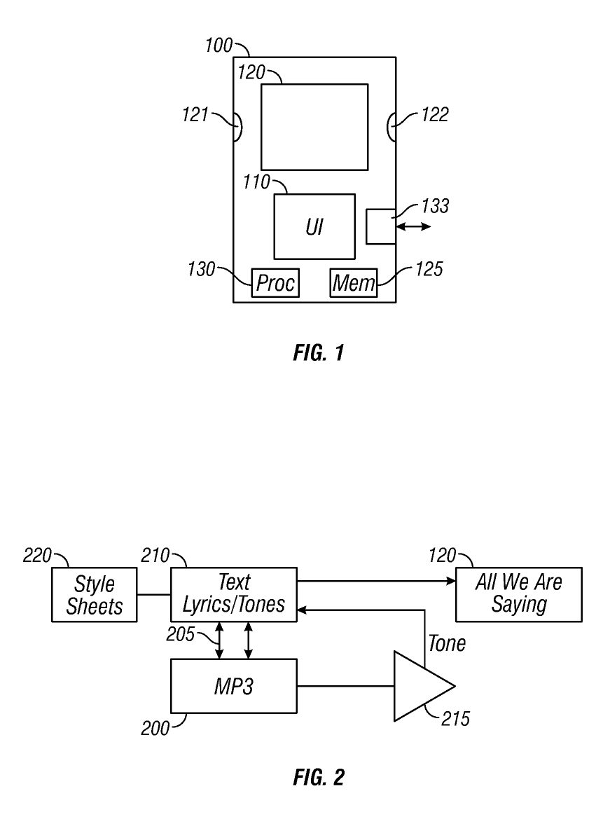

An embodiment describes a karaoke application to be used on a portable phone such as an Iphone. FIG. 1 for example shows the phone, with a user interface 110 that controls operation including controlling of selecting options, making telephone calls, as well as controlling the specific operations described herein. The portable phone also includes a display screen 120, and various kinds of speakers such as 121, 122. The speakers can be used for playing back music. There can also be a headphone jack, or other kinds of ports through which the music is played to an external device. The phone can communicate over different kinds of wireless networks including a cellular network, a Bluetooth network or connection, and wireless ethernet such as WiFi, and as well as over any other wireless network. A communication part 133 may control the communication via any of these wireless networks.

The phone has a memory 125, which can store music therein. The memory 125 can be a static solid-state memory such as flash memory that retains data. The memory 125 can store a number of different formats of information including MP3s, WAV and FLAC format of music, and can also store videos, such as AVI and MPEG 4 videos.

The memory may also store programs that facilitate downloading different kinds of information.

The memory 125 also stores a karaoke application program that is executed by a processor 130. The processor 130 may be the same processor that carries out the communication function on the portable phone; for example it can control dialing of numbers and other functions on the phone.

When the karaoke application is selected via the user interface 110, the display 120 displays karaoke information. That karaoke information allows users to follow along with the words, and to carry out scoring as described herein.

This may be done in different ways according to different embodiments. The downloaded information may be generally shown as FIG. 2. MP3 file 200 can more generally be any kind of playable music file or music video. Either mp3 file 200, or text file 210, or some other stand alone file has information indicative of time synchronization, shown as 205. The time synchronization 205 represents synchronization between different parts of the MP3 file 200 and the text information 210.

The MP3 200 stores the music information, and the text form 210 may store lyric information associated with the music information. The text form 210 also includes times that are used with the synchronization 205. For example, in one embodiment, the processor can keep track of times within the music file 200, for example using embedded time information that is in the MP3 file. The time information stored in the text file can determine when different text should be displayed.

The music 200 is played by a player process shown as 215. The player process detects times of current playing. The current playing time is coupled to the text module 210 which stores lyrics as a function of time. Based on the stored information, the text module outputs the text that is going to be shown, for example on screen 120, at that time. Screen 120 is shown displaying the words “all we are saying”, which are words within the lyrics. The synchronization information 205 ensures that these words are displayed at the same time as those words, in the song, are being played.

In addition to text being stored in the text module 210, the module can also store style sheets 220. The style sheets can either be downloaded as part of the downloaded MP3 200/text 210, or can be style sheets which are individually set within the phone 100. The style sheets can select colors for the background of the display 120. The style sheets can also choose other features, for example they can also select an indicator, e.g., to follow the bouncing ball, or it can follow some other icon on the screen.

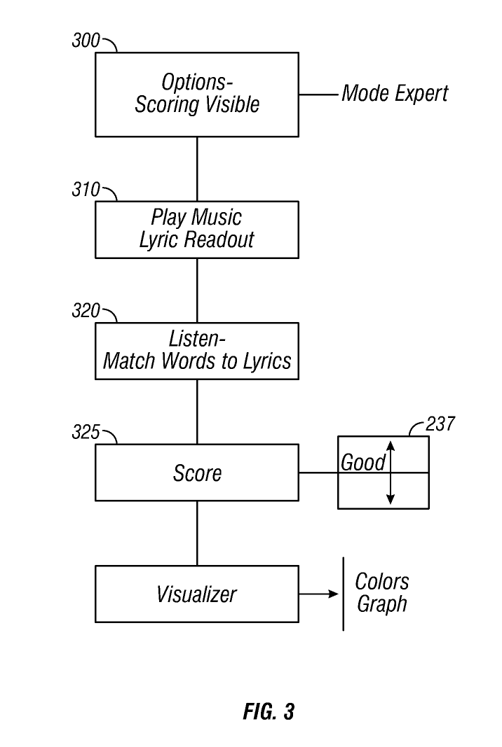

The basic program operates according to the flowchart of FIG. 3. At 300, the user sets options, which can include scoring options, visibility options, and other options.

At 310, the music is played, and in sync with the music being played, the system reads out lyrics from the text store. The lyrics are displayed in sync with the music being played on the system. The sync information 205 is used to keep the music in sync.

At 320, the system obtains sound using its microphone (which can be the same microphone as used for the phone function), and uses a speaker independent voice recognition to match the words that are input through the microphone, to the lyrics. The voice recognition compares the words that are uttered to the text that has been stored.

Based on the matching, at 325, the system analyzes how closely the words which are spoken or sung, match with the actual words from the lyrics that are read out from the text store. A score is assigned to the match depending on the closeness of the match. The score can be shown for example, by a score bar shown as 327, where the score bar can display good or bad, and can change color as the user's score gets better or worse. For example, in the bar shown as 327, a good match (for example greater than 90% of all words match) might be towards the high end of the good match so the bar shows at the high end, and turns green. Less than half or the words matching, for example, might be scoring at the low end of the match bar, and might turn orange or red.

One of the options may select a mode of play—for example, the user can select their mode as being easy, medium, hard or expert. The easier modes may require that the user get fewer of the words right.

In another embodiment the matching of words uttered or sung to text may be matched according to a threshold. A word is established as matching the word in the text if the matching criteria matches by a certain amount. When the mode is selected as being easier, the matching criteria is made easier. In this way, a word that is similar to the correct word may be accepted as correct. For example, for the words above “all we are saying . . . ”, a match may be accepted on the easy setting for “while we are saying . . . ”. However, on the expert setting, that set of words might not be recognized as a match, since it is not exactly the same as the words that are desired.

The expert mode may also require better or more precise temporal synchronization. For example, the expert mode may require the user to have uttered the words “all we are saying” within one second of the time when these words are played by the music. However, the easy mode may allow significantly more time for those words to be uttered, for example 3 to 4 seconds.

Another option of this system displays a visualizer shown as 330. The visualizer, for example, creates certain visible information that is synchronized to the beat. Each time there is a beat of the music, the visualizer can display certain things. Examples of what the visualizer can display include the colors changing at every beat, for example. At each of a plurality of beats, some visible indication may be sent to the display. That is, the display will change according to the beat of the music. The amount by which the display changes may be user-selectable.

As part of the display, the user can also see a tone bar so that the singer can follow along with the tone. The tone bar might go up and down according to the tone in the song, in order to guide the user's tone whether to go up and down. Similarly, the microphone can receive and recognize that tone as part of the scoring.

In an embodiment, text scrolls across bottom of the screen, displaying lyrics of the chosen song. This allows the user to sing along. The scoring bar highlights the words, so player/singer can follow along. A customizable background vibrates and splashes to the beat of the song chosen. The Karaoke interfaces with all platforms and devices via the internet or other device.

The scoring Bar can operate with the different levels as described above—e.g., Easy, Medium, hard and expert.

According to an embodiment, the user interface displays a running total of the score so that the singer can see where they are with a score. The running total can also actuate the scoring bar 327 which can show the user's position e.g. green or red for example.

The embodiment allows colors of bars to light up above words so singer knows what pace to sing. The bar can move up and down depending on pitch, causing the bar to move along with the pace of the song.

One embodiment may allow users to compete against themselves or against friends to see who is the best at the game. The competition may use the scoring system disclosed above.

The visualizer may also include a number of peripheral add-ons. Those add-ons may include Customizable setting, colors, and graphics for the user to choose. As one example, a drummer can choose paint splashes as their background and a guitar player can choose different colors fireworks as background to the beat. Any series of backgrounds can be used. However, the visualizer may set the different backgrounds which are acceptable in this way.

Another embodiment uses 3-D effects along with those add-ons.

The selection of the backgrounds etc. maybe controlled as part of the stylesheets described above.

The hardware can accept its input via wired or wireless communication. The wired mike can use the internal microphone of the cell phone that is used for placing calls. The wireless mike can use a Bluetooth headset.

The system can also include outputs, for example a cord from an IPOD or other music device to stereo/video input (home stereo, TV, car, etc.).

Since the operation is over the Internet, Internet access can be used to download songs and players scores. Users can choose to compete with others across the world, and can provide potential prizes of various types for high scores, including credits good for purchasing additional music or karaoke.

The system may also include options, including options for different languages, and Customizable text font size and color to individual preference as well as other options.

The system can operate using MP3 s, podcasts, any Internet format, and any mobile format.

In another embodiment, instead of the visualization bar, the user can see a simulated icon singer. This allows customizing the displayed to have their own simulated karaoke singer.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other forms of displaying the lyrics and other information can be used. Also, other kinds of connections can be used. For example, while this describes Bluetooth and USB connections, other wireless and wired connections can alternatively be used.

The above has described doing this on an iPhone, however it should be understood that this can also be done on any other phone or any other computer, for example a computer that connects to the Internet. While the above has described one way in which this can be carried out, it can certainly be carried out in other ways.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer system comprising:
a processor; and
a wireless network device, communicating with a wireless network;
said processor running a program that receives music information over said wireless network, and also receives text information over said wireless network, where said text information is associated with said music information and said text includes lyric information about contents of said music information,
and further comprising timing information which defines synchronization between said lyrics in said text information and said music information, said processor programmed to play said music, and to produce outputs indicative of text from said text information, where said outputs indicative of text are created at times which are synchronized to times within said music that is being played,
said processor also programmed to receive an input of a user's voice who is singing along with said music information, automatically recognize words within said input indicative of the user's voice and form information indicative of words which are recognized, and compare said text with said text information that has been received, and automatically form a score that represents an accuracy of the input of the user's voice with the text information at a time that the music information is playing.

2. A computer as in claim 1, further comprising storing at least one stylesheet that represents a way in which information will be displayed.

3. A computer as in claim 2, wherein said program allows different users to select different functions, and said stylesheet provides different backgrounds for said different users, and also controls communicating over a wireless network.

4. A computer as in claim 3, wherein said computer is a cellular phone, and said wireless network includes a cellular network.

5. A computer as in claim 2, wherein said program allows setting comprising plural different options, which effect the way the information is scored and which define the way in which the score is set.

6. A computer as in claim 5, wherein said options include an expert mode in which words in the user's voice are more strictly compared to the text, and an easier mode in which the words in the user's voice are less strictly synchronized to the text.

7. A computer as in claim 6, wherein said expert mode more carefully analyzes the way the words sound relative to the text, and said easier mode less carefully analyzes the way the words sound relative to the text.

8. A computer as in claim 2, further comprising a scoring bar which shows scoring.

9. A computer as in claim 1, wherein said processor is also programmed to download music and text over said wireless network.

10. A computer as in claim 9, wherein said wireless network includes a wireless ethernet network.

11. A cellular telephone system comprising:
a user interface controlling entry of information including information to make a telephone call over the cellular network;
a display, which displays information including information about the telephone call over the cellular network;
a processing part, which runs a stored program to allow operation over the cellular network, said processing part also running a program that receives music information over said cellular network, and also receives text information over said cellular network, where said text information is associated with said music information and said text includes lyric information about said music information and further comprising timing information which defines synchronization between said lyrics in said text information and said music information, said processor programmed to play said music, and to produce outputs indicative of text from said text information, where said outputs indicative of text are at times which are synchronized to times within said music that is being played,
said telephone including a microphone which is used to capture a user's voice to make calls,
said processor also programmed to receive an input of a user's voice who is singing along with said music information over said microphone, to automatically recognize words within said input indicative of the user's voice and form information indicative of words which are recognized, and compare said text with said text information that has been received, and automatically form a score that represents an accuracy of the input of the user's voice with the text information at a time that the music information is playing.

12. A telephone system as in claim 11, further comprising storing at least one stylesheet that represents the way in which said text will be displayed while said music is being played.

13. A telephone system as in claim 12, wherein said program allows different users to select different functions, and said stylesheet provides different backgrounds for said different users, and also controls communicating over a wireless network.

14. A telephone system as in claim 11, wherein said program allows setting comprising plural different options, which effect the way the information is scored and which define the way in which the score is set.

15. A telephone system as in claim 14, wherein said options include an expert mode in which the words in the user's voice are more carefully compared to the text, and an easier mode in which the words in the user's voice are less carefully synchronized to the text.

16. A telephone system as in claim 15, wherein said expert mode more carefully analyzes the way the words sound relative to the real text, and said easier mode less carefully analyzes the way the words sound relative to the real text.

17. A telephone system as in claim 11, wherein said wireless network also includes a wireless ethernet network in addition to said cellular network.

18. A method of operating a cellular telephone comprising:
allowing a user to make a telephone call over a cellular network;
displaying information on the display, said information that is displayed including information about the telephone call over the cellular network;
said cellular telephone having a processor which runs a stored program to receive music information over said cellular network, and also to receive text information over said cellular network, where said text information is associated with said music information and said text includes lyric information about said music information and also to receive timing information which defines synchronization between said lyrics in said text information and said music information;
using said cellular telephone to play said music, and to produce outputs indicative of text from said text information, where said outputs indicative of text are at times which are synchronized to times within said music that is being played;
at a first time, using the microphone within said cellular telephone to capture a user's voice to make calls;
and a second time, using the microphone within the cellular telephone to capture a user's voice who is singing along with said music information over said microphone, to automatically recognize words within said input indicative of the user's voice and form information indicative of words which are recognized, and compare said text with said text information that has been received, and
automatically form a score that represents an accuracy of the input of the user's voice with the text information at a time that the music information is playing.

19. A method as in claim 18, further comprising displaying information on the display as part of the program that plays music and text.

20. A method as in claim 19, further comprising displaying said information according to at least one stylesheet that represents the way in which said text will be displayed while said music is being played.

21. A method as in claim 19 further comprising setting difficulty modes for said scoring.

22. A method as in claim 21, wherein said difficulty modes include an expert mode in which the words in the user's voice are more carefully compared to the text, and an easier mode in which the words in the user's voice are less carefully synchronized to the text.

23. A telephone system as in claim 22, wherein said expert mode more carefully analyzes the way the words sound relative to the real text, and said easier mode less carefully analyzes the way the words sound relative to the real text.
